(19) United States
(12) Patent Application Publication
(10) Pub. No.: US 2022/0281467 A1
(43) Pub. Date: Sep. 8, 2022

(54) FAILURE SYMPTOM SENSING SYSTEM, VEHICLE, FAILURE SYMPTOM SENSING METHOD, AND COMPUTER-READABLE RECORDING MEDIUM

(71) Applicant: HONDA MOTOR CO.,LTD., Tokyo (JP)

(72) Inventor: Fumihiro YOSHINO, Saitama (JP)

(21) Appl. No.: 17/666,566

(22) Filed: Feb. 8, 2022

(30) Foreign Application Priority Data
Mar. 4, 2021 (JP) 2021-034255

(51) Int. Cl. B60W 50/02; B60W 40/105; B60W 40/04

(52) U.S. Cl. CPC B60W 50/0205; B60W 40/105; B60W 40/04; B60W 2050/021; B60W 2050/0215; B60W 2540/10; B60W 2554/406; B60W 2555/20; B60W 2556/10; B60W 2556/60

(57) ABSTRACT

A failure symptom sensing system may comprise a determination unit configured to determine whether a traveling state of a vehicle after a predetermined time period is in a predetermined traveling state based on location information of the vehicle and a driving history information of the vehicle. A failure symptom sensing system may comprise a sensing unit configured to acquire data from a sensor configured to sense a state of the vehicle to sense whether a symptom of failure of the vehicle exists based on the data when the traveling state of the vehicle after the predetermined time period is determined to be the predetermined traveling state.

The contents of the following Japanese patent application are incorporated herein by reference:

No. 2021-034255 filed in JP on Mar. 4, 2021.

### BACKGROUND

### 1. Technical Field

The present invention relates to a failure symptom sensing system, a vehicle, a failure symptom sensing method, and a computer-readable recording medium.

### 2. Related Art

Patent document 1 describes a failure symptom diagnosis apparatus detecting a symptom of an abnormality of an in-vehicle electronic component when the number of occurring events of abnormal factors in the external environment of the in-vehicle electronic component exceeds a predetermined symptom detection threshold.

### PRIOR ART DOCUMENT

### Patent Document

Patent document 1: Japanese Patent Application Publication No. 2011-189788

### BRIEF DESCRIPTION OF THE DRAWINGS

FIG. 1 schematically illustrates a vehicle according to the present embodiment.

FIG. 2 schematically illustrates a system configuration of a control system.

FIG. 3 is a flowchart illustrating one example of a failure symptom sensing procedure.

FIG. 4 illustrates one example of a hardware configuration.

### DESCRIPTION OF EXEMPLARY EMBODIMENTS

Hereinafter, the present invention will be described through embodiments of the invention, but the following embodiments do not limit the invention according to the claims. In addition, not all combinations of features described in the embodiments necessarily have to be essential to solving means of the invention.

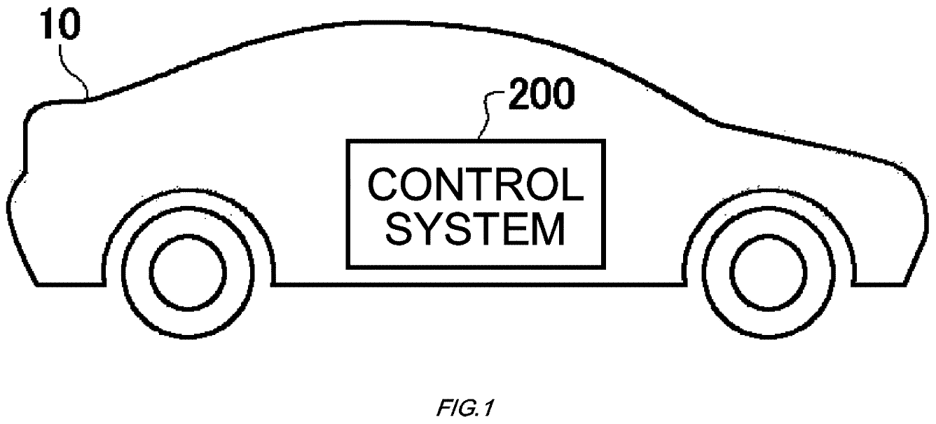

FIG. 1 schematically illustrates a vehicle 10 according to the present embodiment. The vehicle 10 includes a control system 200 for controlling the vehicle 10. In the present embodiment, a hybrid vehicle is used for describing the vehicle 10 as an example. However, the vehicle 10 may be a vehicle driven by any drive system, such as an engine vehicle and an electric vehicle.

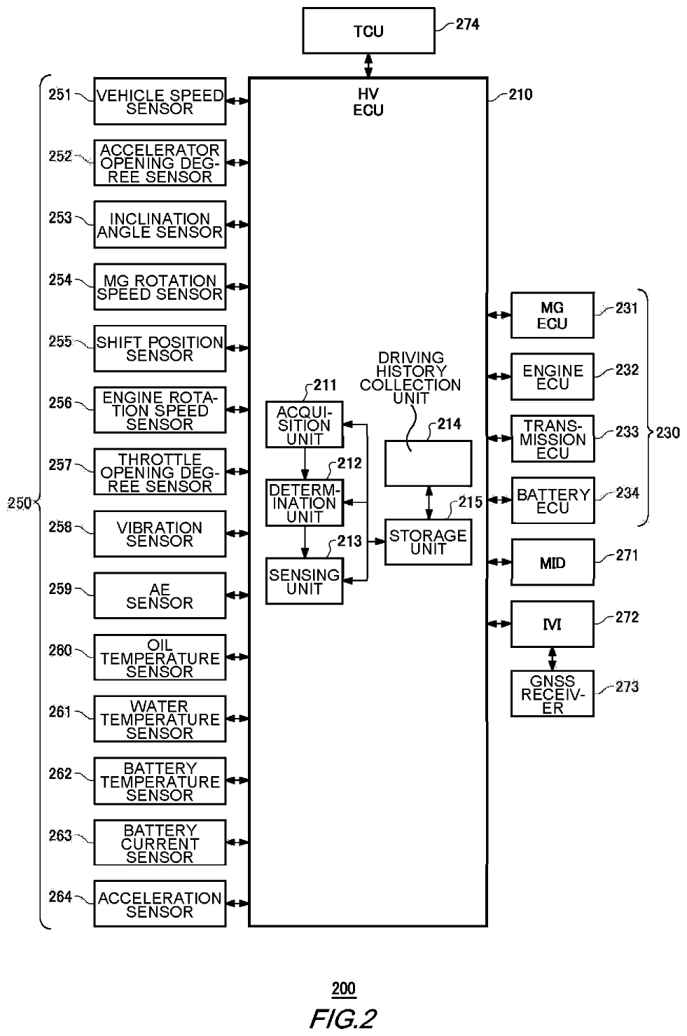

FIG. 2 schematically illustrates a system configuration of a control system 200. Control system 200 includes an HVECU 210, various ECUs 230, various sensors 250, a MID 271, an IVI 272, a GNSS receiver 273, and TCU 274.

The HVECU 210 is a hybrid ECU (Electronic Control Unit) for controlling the vehicle 10. The HVECU 210 and various ECUs 230 may be configured to include a so-called microcomputer consisting of a CPU, a ROM, a RAM, an input/output interface, and the like. The HVECU 210 processes a signal in accordance with a program stored in advance in the ROM while utilizing a temporary storage function of the RAM.

The HVECU 210 is connected to the MID 271, the IVI 272, the TCU 274, and each ECU 230 via an in-vehicle communication line. The HVECU 210 communicates with the MID 271, the IVI 272, the TCU 274, and various ECUs 230 via the in-vehicle communication line. The HVECU 210 integrally controls the MID 271, the IVI 272, the TCU 274, and each ECU 230 via the in-vehicle communication line. The in-vehicle communication line may be configured to include, for example, a CAN (Controller Area Network), an EtherNetwork, or the like.

The MID 271 is a multi-information display. The IVI 272 is a piece of in-vehicle infotainment (IVI) information equipment. The MID 271 and the IVI 272 are connected to the HVECU 210 via the in-vehicle communication line. The MID 271 and the IVI 272 may function as display control units. The IVI 272 has a wireless LAN communication function. The GNSS receiver 273 identifies the location of the vehicle 10 based on a signal received from a GNSS (Global Navigation Satellite System) satellite.

The IVI 272 acquires location information of the vehicle 10 from the GNSS receiver 273. The IVI 272 outputs the location information acquired from the GNSS receiver 273 to the HVECU 210.

The TCU 274 is a telematics control unit. The TCU 274 is mainly responsible for mobile communication. The TCU 274 sends data to and receives data from an external apparatus according to the control by the HVECU 210.

Each ECU 230 includes an MGECU 231, an engine ECU 232, a transmission ECU 233, and a battery ECU 234. The MGECU 231 controls a motor generator for driving, mounted on the vehicle 10. The engine ECU 232 controls the engine mounted on the vehicle 10. The transmission ECU 233 controls the transmission mounted on the vehicle 10. The battery ECU 234 control a battery which is a high-voltage battery mounted on the vehicle 10.

The HVECU 210 executes a hybrid drive control relating to the motor generator via MGECU 231 and the engine via the engine ECU 232. The HVECU 210 executes a shift control of the transmission via the transmission ECU 233. The HVECU 210 controls the charge/discharge of the battery via the battery ECU 234.

The various sensors 250 include a vehicle speed sensor 251, an accelerator opening degree sensor 252, an inclination angle sensor 253, an MG rotation speed sensor 254, a shift position sensor 255, an engine rotation speed sensor 256, a throttle opening degree sensor 257, a vibration sensor 258, an AE sensor 259, an oil temperature sensor 260, a water temperature sensor 261, battery temperature sensor 262, a battery current sensor 263, and an acceleration sensor 264. The various sensors 250 may include other sensors.

The vehicle speed sensor 251 detects the vehicle speed of the vehicle 10. The accelerator opening degree sensor 252 detects the accelerator opening degree by the operation of a driver, that is, an operation quantity of an accelerator pedal. The inclination angle sensor 253 detects the inclination of the vehicle 10. The MG rotation speed sensor 254 detects the rotation speed of the motor generator. The shift position sensor 255 detects the shift position of a shift lever. The engine rotation speed sensor 256 detects the rotation speed of the engine. The throttle opening degree sensor 257 detects the opening degree of a throttle valve of the engine. The battery temperature sensor 262 detects the temperature of the battery. The battery current sensor 263 detects the charging or discharging current of the battery.

The HVECU 210 sets a required driving force based on the vehicle speed detected by the vehicle speed sensor 251 and the accelerator opening degree detected by the accelerator opening degree sensor 252. The HVECU 210 determines whether the vehicle 10 is at the time of start based on the vehicle speed detected by the vehicle speed sensor 251. The HVECU 210 determines whether the vehicle 10 is on an uphill road or a downhill road based on the inclination angle detected by the inclination angle sensor 253. The engine ECU 232 controls an output torque from the engine in accordance with the set required driving force based on the instruction from the HVECU 210. The MGECU 231 controls the output torque from the motor generator in accordance with the set required driving force based on the instruction from the HVECU 210. The transmission ECU 233 performs the shift control of the transmission in accordance with the set required driving force.

The battery ECU 234 controls the charge/discharge of the battery based on battery information indicating the state of the battery, such as an inter-terminal voltage of the battery, the charging or discharging current of the battery from the battery current sensor 263, and the battery temperature from the battery temperature sensor 262. The battery ECU 234 computes the charge amount (SOC) based on an integrated value of the charging or discharging current of the battery.

The vibration sensor 258 senses the vibration of a portion of the vehicle 10, which allows sensing the symptom of failure of the vehicle 10, such as the vibration of the vehicle 10, the vibration of the engine, the vibration of the transmission, the vibration of the suspension, for example. The AE sensor 259 is an Acoustic Emission sensor. The AE sensor 259 is a sensor for detecting ultrasonic and elastic wave energy occurring following a phenomenon such as the deformation, progress of crack, and delamination of an object. The AE sensor 259 may be provided at a portion of the vehicle 10 that allows sensing the symptom of failure of the vehicle 10, such as the engine. The oil temperature sensor 260 detects the temperature of the engine oil (oil temperature), for example. The water temperature sensor 261 detects, for example, the temperature of cooling water flowing in a water jacket which is a cooling water channel formed in a cylinder head and a cylinder. The acceleration sensor 264 detects the acceleration of the vehicle 10 in order to determine whether the vehicle 10 is in an acceleration state, a deceleration state, or a constant speed state (cruise state).

In the control system 200 configured as described above, the symptom of failure of the vehicle 10 is sensed based on various types of data collected from the various sensors 250.

In the present embodiment, the HVECU 210 functions as a failure symptom sensing system for sensing the symptom of failure of the vehicle 10. It should be noted that an ECU other than the HVECU 210 may function as a failure symptom sensing system.

If the HVECU 210 continuously senses the symptom of failure of the vehicle 10 based on various types of data collected by the various sensors 250 while the vehicle 10 is in a travelable state, the processing burden of the HVECU 210 increases. The power consumed in the HVECU 210 also increases. Meanwhile, the HVECU 210 is not necessarily able to sense the symptom of failure of the vehicle 10 with a high precision based on the various types of data collected by the various sensors 250 while the vehicle 10 is in a travelable state.

Therefore, in the present embodiment, the HVECU 210 senses the symptom of failure of the vehicle 10 while the traveling state of the vehicle 10 is a traveling state suitable for sensing the symptom of failure of the vehicle 10.

The HVECU 210 includes an acquisition unit 211, a determination unit 212, a sensing unit 213, a driving history collection unit 214, and a storage unit 215. The driving history collection unit 214 collects driving history information of the vehicle 10 from the various sensors 250 and each ECU 230 and store the information in the storage unit 215. The driving history information indicates a past traveling state of the vehicle 10. The driving history information indicates the traveling state of the vehicle 10 on a past driving route. The driving history information indicates whether the vehicle 10 on the past driving route of the vehicle 10 is in an acceleration state, a deceleration state, or a constant speed state.

The driving history information may include a time period during which the vehicle was driven, a clock time at which the vehicle was driven, a driving route at each clock time, a location of the vehicle 10 at each clock time, a speed of the vehicle 10 at each clock time, an acceleration of the vehicle 10 at each clock time, operation contents by the user at each clock time, and the like. The operation contents may include a command value for each portion at each clock time that each of the various ECUs 230 has commanded to a drive unit, such as the engine or the motor generator. The operation contents may include an operation quantity of the handle at each clock time, a stepping amount of the accelerator pedal at each clock time, a stepping amount of the brake pedal at each clock time, and the like. The driving history information may include weather information at a clock time at which the vehicle was driven, traffic jam information about a driving route at each clock time, and the like.

The acquisition unit 211 acquires location information of the vehicle 10 acquired by the GNSS receiver 273 via the IVI 272. The acquisition unit 211 acquires driving history information collected by the driving history collection unit 214 and stored in the storage unit 215.

The determination unit 212 determines whether the traveling state of the vehicle 10 after a predetermined time period is a predetermined traveling state based on the location information of the vehicle 10 acquired by the acquisition unit 211 and the driving history information of the vehicle 10. The predetermined time period may be, for example, five seconds, thirty seconds, one minute, five minutes, ten minutes, thirty minutes, one hour or the like. The predetermined time period may be any time period as long as the time period elapses after a time period from the instruction of starting the data acquisition to a sensor 250 to the start of the data acquisition elapses. The predetermined time period may be set in the factory before shipping the vehicle 10, for example.

The determination unit 212 may determine whether the traveling state of the vehicle after the predetermined time period is the predetermined traveling state by determining whether the traveling state of the vehicle 10 after the predetermined time period is a state in which the vehicle continues to be in an acceleration state, a deceleration state, or a constant speed state for a predetermined period or more, based on the location information of the vehicle 10 and the driving history information of the vehicle 10. The predetermined traveling state is a state where whether a symptom of failure of the vehicle 10 exists can be sensed based on the data from a sensor 250. The predetermined traveling state is a state where the traveling state of the vehicle 10 is stable for a predetermined period (for example, five seconds) or more. The predetermined traveling state may be a state where the vehicle 10 drives at a constant speed on a highway for a predetermined period or more, for example. The predetermined traveling state may be a state where the vehicle 10 drives at a vehicle speed of 60 km/h for five seconds or more, for example. The predetermined traveling state may be a state where the vehicle 10 drives on an upward slope or drives on a downward slope for a predetermined period or more. The predetermined traveling state may be a state where the vehicle 10 is stopping at an intersection for a predetermined period or more. The predetermined traveling state may be set in the factory before shipping vehicle 10, for example. The predetermined period may be a period in which enough amount of data to sense whether the symptom of failure of the vehicle 10 exists can be acquired from a sensor 250. The predetermined period may be five seconds, ten seconds, thirty seconds, one minute, ten minutes, fifteen minutes, or the like, for example. The predetermined period may be set in the factory before shipping the vehicle 10, for example.

The determination unit 212 determines whether there exists a past driving history of the vehicle 10 on a driving route where the vehicle 10 is currently located. The determination unit 212 may acquire a route scheduled to be traveled by the vehicle 10 from a navigation system to determine whether a driving history on a past driving route same as the route scheduled to be traveled is included in the driving history information. If a past driving history of the vehicle 10 on a driving route where the vehicle 10 is currently located exists, the determination unit 212 identifies an area, in the driving route, where an acceleration state, a deceleration state, or a constant speed state continues for a predetermined period (for example five seconds) or more. From a plurality of driving histories of the vehicle 10 on the same past driving route, the determination unit 212 may identify an area, in the driving route, where the probability that an acceleration state, a deceleration state, or a constant speed state continues for a predetermined period (for example five seconds) or more is higher than a threshold.

If an area where an acceleration state, a deceleration state, or a constant speed state continues for a predetermined period (for example five seconds) or more exists on the current driving route of the vehicle 10, the determination unit 212 determines whether the vehicle 10 after the predetermined time period reaches the area where the acceleration state, the deceleration state, or the constant speed state continues, based on the current location of the vehicle 10, the current speed of the vehicle 10, and the accelerator opening degree. When the vehicle 10 after the predetermined time period is determined to reach the area where the acceleration state, the deceleration state, or the constant speed state continues, the determination unit 212 determines the traveling state of the vehicle 10 after the predetermined time period is the predetermined traveling state.

The determination unit 212 may identify an area where an acceleration state, a deceleration state, or a constant speed state continues for a predetermined period (for example five seconds) or more in a driving route under the current weather condition, based on a driving history of the vehicle 10 on the driving route under the same weather condition as the current weather condition. The determination unit 212 may identify an area where an acceleration state, a deceleration state, or a constant speed state continues for a predetermined period (for example five seconds) or more in a driving route under the current weather condition, based on a driving history of the vehicle 10 on a past driving route in a traffic congestion state same as the current traffic congestion state.

When the traveling state of the vehicle 10 after the predetermined time period is determined to be the predetermined traveling state, the sensing unit 213 acquires data from a sensor 250 for sensing a state of the vehicle and senses whether the symptom of failure of the vehicle exists based on the data. The sensing unit 213, for example, acquires data from the vibration sensor 258 for detecting the vibration of a predetermined portion of the vehicle and senses whether the symptom of failure of the vehicle exists based on the acquired data.

The sensing unit 213 may acquire data from each vibration sensor 258 for detecting the vibration of each portion constituting a drive unit for driving the vehicle 10. The sensing unit 213 may acquire data from the vibration sensor 258 for detecting the vibration of the engine, the vibration of the motor generator, the vibration of the transmission, the vibration of the clutch, or the vibration of the suspension. The sensing unit 213 may perform a fast Fourier transform (FFT) process of the data acquired from the vibration sensor 258 to decompose the data into frequency components. The sensing unit 213 may determine whether a predetermined frequency component indicating a symptom of failure of the engine, the motor generator, the transmission, the clutch, or the suspension is included in the decomposed frequency components. Also, the sensing unit 213 may determine whether each of the decomposed frequency components falls within a range of a normal frequency component of the vibration of the engine, the motor generator, the transmission, the clutch, or the suspension. The sensing unit 213 may determine whether a predetermined frequency component indicating a symptom of failure of a predetermined portion, for example, a gear or bearing constituting the transmission, or a rotor of the motor generator, is included in the frequency components decomposed from the data. When any of the decomposed frequency components does not satisfy the condition of the predetermined normal frequency component, the sensing unit 213 may determine that a symptom of failure exists in the applicable portion.

The sensing unit 213 may acquire data from the oil temperature sensor 260 for detecting the engine oil temperature of the vehicle 10. The sensing unit 213 may determine whether the oil temperature indicated by data from the oil temperature sensor 260 falls within a predetermined temperature range of the engine oil. When the oil temperature detected by the oil temperature sensor 260 does not fall within the predetermined temperature range, the sensing unit 213 determines that a symptom of failure exists in the engine.

The sensing unit 213 may acquire data from at least one of the current sensor for detecting the current input into the motor generator of the vehicle 10, and the rotation speed sensor for detecting the rotation speed of the motor generator, and determine whether the current value indicated by the acquired data falls within a predetermined range of the current value, or the rotation speed indicated by the acquired data falls within a predetermined range of the rotation speed. When the current value does not fall within the predetermined range of the current value, or the rotation speed does not fall within the predetermined range of the rotation speed, the sensing unit 213 may determine that a symptom of failure exists in the motor generator.

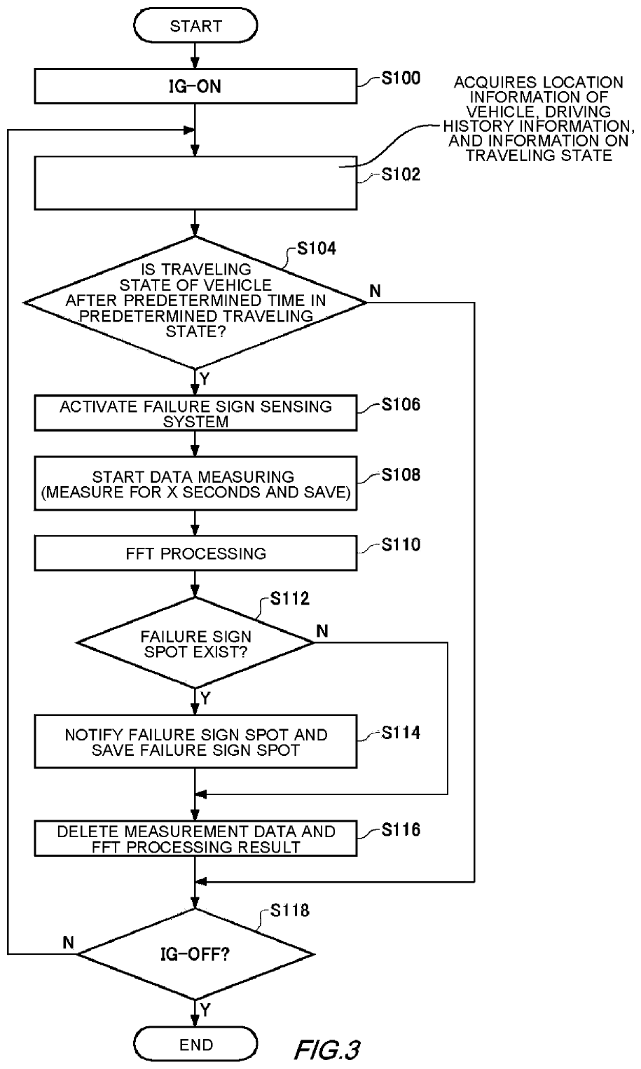

FIG. 3 is a flowchart illustrating one example of a failure symptom sensing procedure by the HVECU 210.

After the HVECU 210 senses an ON signal of an ignition switch, the vehicle 10 becomes a travelable state, and the vehicle 10 starts driving. Then, the acquisition unit 211 acquires the location information of the vehicle 10, the driving history information, and information about the current traveling state of the vehicle 10 (for example, the vehicle speed and accelerator opening degree of the vehicle 10) (S102).

The determination unit 212 determines whether the traveling state of the vehicle 10 after the predetermined time period is the predetermined traveling state based on the location information, the driving history information, and the information about the current traveling state of the vehicle 10 (S104).

When the traveling state of the vehicle 10 after the predetermined time period is the predetermined traveling state, the HVECU 210 activates the failure symptom sensing system (S106) and starts data measuring (S108). The HVECU 210 continues the data measuring for a predetermined X second(s) (for example, five seconds) to save the measurement data in the storage unit 215. In other words, the sensing unit 213 acquires data from a sensor 250 for sensing the state of the vehicle to save the data in the storage unit 215. The sensing unit 213 performs the FFT processing of the data collected from a sensor 250 to decompose the data into frequency components (S110). When any of the decomposed frequency components applies to a frequency component indicating a failure symptom, the sensing unit 213 determines that a symptom of failure exists in the applicable part. The sensing unit 213 may sense a failure symptom spot (such as the engine, the transmission, the motor generator, the clutch, or the suspension) based on the result of FFT processing of various types of data collected from a sensor 250.

When a failure symptom spot exists (S112), the sensing unit 213 notifies the user of the failure symptom spot and saves information of the failure symptom spot in the storage unit 215 (S114). The sensing unit 213 may display a message on a display such as the MID 271 to indicate the failure symptom spot and encourage the user to go to a dealer, to notify the user of the failure symptom spot.

When no failure symptom spot exists, or after saving the failure symptom spot in the storage unit 215, the sensing unit 213 deletes the measurement data and the result of the FFT processing saved in the storage unit 215 (S116).

After the measurement data and the result of the FFT processing are deleted, or when the traveling state of the vehicle 10 after the predetermined time period is not the predetermined traveling state, the process from step S102 to step S116 is repeated until the ignition switch turns off (S118).

According to the present embodiment, the HVECU 210 senses the symptom of failure of the vehicle 10 only while the traveling state of the vehicle 10 is the traveling state suitable for sensing the symptom of failure of the vehicle 10. Therefore, the processing burden of the HVECU 210 can be prevented from increasing, by the continuous sensing of the symptom of failure of the vehicle 10 by the HVECU 210 based on various types of data collected from various sensors 250 while the vehicle 10 is in a travelable state. This also can prevent the power consumed in the HVECU 210 from increasing.

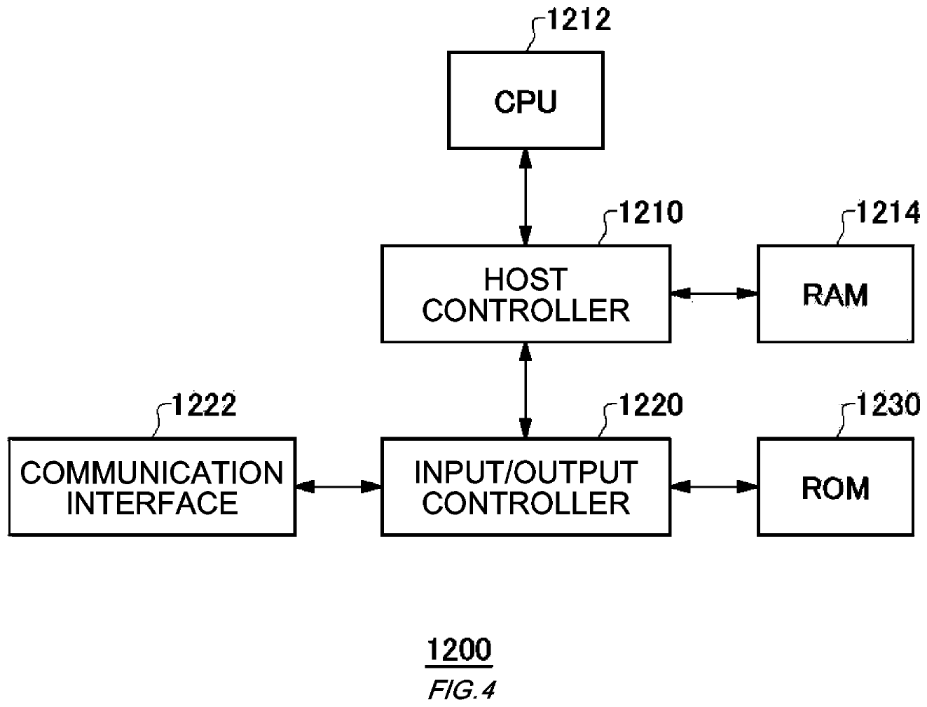

FIG. 4 illustrates one example of a computer 1200 in which a plurality of embodiments of the present invention may be entirely or partially embodied. A program installed in the computer 1200 can cause the computer 1200 to function as an operation associated with an apparatus according to the embodiments of the present invention or one or more “units” of the apparatus. Alternatively, the program can cause the computer 1200 to execute the operation or the one or more “units. The program can cause the computer 1200 to execute a process according to the embodiments of the present invention or a step of the process. Such a program may be executed by a CPU 1212 in order to cause the computer 1200 to execute a specific operation associated with some or all of the blocks in the flowcharts and block diagrams described herein.

The computer 1200 according to the present embodiment includes the CPU 1212 and a RAM 1214, which are mutually connected by a host controller 1210. The computer 1200 also includes a communication interface 1222, and an input/output unit, which are connected to the host controller 1210 via an input/output controller 1220. The computer 1200 also includes a ROM 1230. The CPU 1212 operates in accordance with programs stored in the ROM 1230 and the RAM 1214 to control each unit.

The communication interface 1222 communicates with other electronic devices via a network. A hard disk drive may store the program and data used by the CPU 1212 in the computer 1200. The ROM 1230 stores a boot program or the like executed by the computer 1200 during activation, and/or a program depending on the hardware of the computer 1200. The program is provided via a computer-readable recording medium, such as a CD-ROM, a USB memory, or an IC card, or a network. The program is installed in the RAM 1214 or the ROM 1230, which is an example of the computer-readable recording medium and is executed by the CPU 1212. Information processing described in those programs is read by the computer 1200 and provides cooperation between the programs and the above-described various types of hardware resources. The apparatus or method may be configured by realizing operation or processing of information according to the use of the computer 1200.

For example, when communication is performed between the computer 1200 and an external device, the CPU 1212 may execute a communication program loaded in the RAM 1214, and instruct the communication interface 1222 to execute communication processing based on the processing written in the communication program. The communication interface 1222, under control of the CPU 1212, reads transmission data stored in a transmission buffer region provided in a recording medium such as the RAM 1214 or the USB memory, transmits the read transmission data to the network, and writes reception data received from the network into a reception buffer region or the like provided on the recording medium.

Also, the CPU 1212 may cause all or a necessary portion of a file or a database stored in the external recording medium such as the USB memory or the like, to be read by the RAM 1214, and may execute various types of processing on the data on the RAM 1214. Next, the CPU 1212 may write back the processed data into the external recording medium.

Various types of information such as various types of programs, data, tables, and a database may be stored in the recording medium and may be subjected to information processing. The CPU 1212 may execute, on the data read from the RAM 1214, various types of processing including various types of operations, information processing, conditional judgment, conditional branching, unconditional branching, information retrieval/replacement, or the like described herein and specified by instruction sequences of the programs, and writes back the results into the RAM 1214. Also, the CPU 1212 may retrieve information in a file, a database, or the like in the recording medium. For example, in a case where a plurality of entries, each having an attribute value of a first attribute associated with an attribute value of a second attribute, are stored in the recording medium, the CPU 1212 may retrieve, from among the plurality of entries, an entry that meets a condition whose attribute value of the first attribute is designated, read the attribute value of the second attribute stored in said entry, and thereby acquire the attribute value of the second attribute associated with the first attribute meeting a predetermined condition.

The above-described programs or software module may be stored on the computer 1200 or in the computer-readable storage medium in the vicinity of the computer 1200. Also, a recording medium such as a hard disk or RAM provided in a server system connected to a dedicated communication network or the Internet can be used as the computer-readable storage medium, and thereby providing the programs to the computer 1200 via the network.

The computer-readable medium may include any tangible device capable of storing an instruction executed by an appropriate device. As a result, the computer-readable medium having the instruction stored therein includes a product including an instruction which may be executed to create means for executing an operation specified in the flowchart or block diagram. Examples of computer-readable media may include an electronic storage medium, a magnetic storage medium, an optical storage medium, an electromagnetic storage medium, a semiconductor storage medium, and the like. More specific examples of computer-readable media may include a Floppy (registered trademark) disk, a diskette, a hard disk, a random access memory (RAM), a read-only memory (ROM), an erasable programmable read-only memory (EPROM or Flash memory), an electrically erasable programmable read-only memory (EEPROM), a static random access memory (SRAM), a compact disc read-only memory (CD-ROM), a digital versatile disk (DVD), a BLU-RAY (registered trademark) disc, a memory stick, an integrated circuit card, and the like.

The computer-readable instruction may include any one of a source code or an object code described in any combination of one or more programming languages. The source code or the object code includes a conventional procedural programming language. The conventional procedural programming language may be an assembler instruction, an instruction-set-architecture (ISA) instruction; a machine instruction; a machine-dependent instruction; a microcode; a firmware instruction; state-setting data; or an object-oriented programming language such as Smalltalk (registered trademark), JAVA (registered trademark), C++, or the like; and a “C” programming language or a similar programming language. The computer-readable instruction may be provided to a general-purpose computer, a special-purpose computer, or a processor or a programmable circuit of another programmable data processing apparatus, locally or via a local area network (LAN), a wide area network (WAN) such as the Internet or the like. The processor or the programmable circuitry may execute the computer-readable instruction in order to create means for executing the operation specified in the flowchart or the block diagram. Examples of the processor include a computer processor, processing unit, microprocessor, digital signal processors, controller, microcontroller, or the like.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: vehicle

200: control system

210: HVECU

211: acquisition unit

212: determination unit

213: sensing unit

214: driving history collection unit

215: storage unit

230: ECU

231: MGECU

232: engine ECU

233: transmission ECU

234: battery ECU

250: sensor

251: vehicle speed sensor

252: accelerator opening degree sensor

253: inclination angle sensor

254: MG rotation speed sensor

255: shift position sensor

256: engine rotation speed sensor

257: throttle opening degree sensor

258: vibration sensor

259: AE sensor

260: oil temperature sensor

261: water temperature sensor

262: battery temperature sensor

263: battery current sensor

264: acceleration sensor

271: MID

272: IVI

273: GNSS receiver

274: TCU

1200: computer

1210: host controller

1212: CPU

1214: RAM

1230: ROM

1220: input/output controller

1222: communication interface

What is claimed is:

1. A failure symptom sensing system, comprising:
a determination unit configured to determine whether a traveling state of a vehicle after a predetermined time period is a predetermined traveling state based on location information of the vehicle and a driving history information of the vehicle; and
a sensing unit configured to sense whether a symptom of failure of the vehicle exists, based on data acquired from a sensor configured to sense a state of the vehicle, when the traveling state of the vehicle after the predetermined time period is determined to be the predetermined traveling state.

2. The failure symptom sensing system according to claim 1, wherein the determination unit is configured to determine whether the traveling state of the vehicle after the predetermined time period is the predetermined traveling state by determining whether the traveling state of the vehicle after the predetermined time period is a state in which the vehicle continues to be in an acceleration state, a deceleration state, or a constant speed state for a predetermined period or more, based on the location information of the vehicle and the driving history information of the vehicle.

3. The failure symptom sensing system according to claim 1, wherein
the sensor includes a vibration sensor configured to detect a vibration of a predetermined portion of the vehicle, and
the sensing unit is configured to sense whether a symptom of failure exists in a predetermined component mounted on the vehicle based on a frequency of the vibration detected by the vibration sensor.

4. The failure symptom sensing system according to claim 2, wherein
the sensor includes a vibration sensor configured to detect a vibration of a predetermined portion of the vehicle, and
the sensing unit is configured to sense whether a symptom of failure exists in a predetermined component mounted on the vehicle based on a frequency of the vibration detected by the vibration sensor.

5. The failure symptom sensing system according to claim 1, wherein the determination unit is configured to determine whether the traveling state of the vehicle after the predetermined time period is the predetermined traveling state further based on information about a current traveling state of the vehicle.

6. The failure symptom sensing system according to claim 2, wherein the determination unit is configured to determine whether the traveling state of the vehicle after the predetermined time period is the predetermined traveling state further based on information about a current traveling state of the vehicle.

7. The failure symptom sensing system according to claim 3, wherein the determination unit is configured to determine whether the traveling state of the vehicle after the predetermined time period is the predetermined traveling state further based on information about a current traveling state of the vehicle.

8. The failure symptom sensing system according to claim 5, wherein the information about the current traveling state of the vehicle includes at least one of a vehicle speed of the vehicle and an accelerator opening degree of the vehicle.

9. The failure symptom sensing system according to claim 1, wherein the determination unit is configured to determine whether the traveling state of the vehicle after the predetermined time period is the predetermined traveling state further based on traffic jam information.

10. The failure symptom sensing system according to claim 2, wherein the determination unit is configured to determine whether the traveling state of the vehicle after the predetermined time period is the predetermined traveling state further based on traffic jam information.

11. The failure symptom sensing system according to claim 3, wherein the determination unit is configured to determine whether the traveling state of the vehicle after the predetermined time period is the predetermined traveling state further based on traffic jam information.

12. The failure symptom sensing system according to claim 4, wherein the determination unit is configured to determine whether the traveling state of the vehicle after the predetermined time period is the predetermined traveling state further based on traffic jam information.

13. The failure symptom sensing system according to claim 1, wherein the determination unit is configured to determine whether the traveling state of the vehicle after the predetermined time period is the predetermined traveling state further based on weather information.

14. The failure symptom sensing system according to claim 2, wherein the determination unit is configured to determine whether the traveling state of the vehicle after the predetermined time period is the predetermined traveling state further based on weather information.

15. The failure symptom sensing system according to claim 3, wherein the determination unit is configured to determine whether the traveling state of the vehicle after the predetermined time period is the predetermined traveling state further based on weather information.

16. A vehicle configured to drive with the failure symptom sensing system according to claim 1 mounted thereon.

17. A vehicle configured to drive with the failure symptom sensing system according to claim 2 mounted thereon.

18. A vehicle configured to drive with the failure symptom sensing system according to claim 3 mounted thereon.

19. A failure symptom sensing method, comprising:
determining whether a traveling state of a vehicle after a predetermined time period is a predetermined traveling state based on location information of the vehicle and a driving history information of the vehicle; and
sensing whether a symptom of failure of the vehicle exists, based on data acquired from a sensor configured to sense a state of the vehicle, when the traveling state of the vehicle after the predetermined time period is determined to be the predetermined traveling state.

20. A computer-readable recording medium having recorded thereon a program to cause a computer to perform operations comprising:
determining whether a traveling state of a vehicle after a predetermined time period is in a predetermined traveling state based on location information of the vehicle and a driving history information of the vehicle; and
sense whether a symptom of failure of the vehicle exists, based on data acquired from a sensor configured to sense a state of the vehicle, when the traveling state of the vehicle after the predetermined time period is determined to be the predetermined traveling state.
